(19) United States
(12) Patent Application Publication
(10) Pub. No.: US 2024/0430783 A1
(43) Pub. Date: Dec. 26, 2024

(54) METHODS AND DEVICES SHARING AIML PROFILES IN A WIRELESS NETWORK

(71) Applicant: CANON KABUSHIKI KAISHA, Tokyo (JP)

(72) Inventors: Yuki FUJIMORI, RENNES (FR); Julien SEVIN, SAINT AUBIN DU CORMIER (FR)

(21) Appl. No.: 18/749,037

(22) Filed: Jun. 20, 2024

(30) Foreign Application Priority Data
Jun. 22, 2023 (GB) 2309424.6

(51) Int. Cl. H04W 48/10; H04W 28/02; H04W 28/16

(52) U.S. Cl. CPC H04W 48/10; H04W 28/0215; H04W 28/16

(57) ABSTRACT

The invention concerns the advertisement of Artificial Intelligence and Machine Learning, AIML, capabilities between stations of a wireless network. AIML technology can be used to drive communication features or mechanisms within the network. A first station transmits, to a second station, a management frame including AIML profile information defining a profile of AIML capabilities at the first station. The AIML profile information is based on pre-defined AIML profiles or sub-profiles. A non-AP station may receive such AIML profile information from two or more AP stations and then select one of these AP stations that best matches its own AIML capabilities, to join its BSS. Similarly, an AP station receiving such AIML profile information from a non-AP station may decide whether to accept or refuse an association of the non-AP station to its BSS.

This application claims the benefit under 35 U.S.C. § 119(a)-(d) of United Kingdom Patent Application No. 2309424.6, filed on Jun. 22, 2023 and entitled “Methods and devices sharing AIML profiles in a wireless network”. The above cited patent application is incorporated herein by reference in its entirety.

### FIELD OF THE INVENTION

The present invention relates to wireless communications and more specifically to AIML (Artificial Intelligence and Machine Learning) profile exchange via wireless communications.

### BACKGROUND OF THE INVENTION

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section. Furthermore, all embodiments are not necessarily intended to solve all or even any of the problems brought forward in this section.

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks. The 802.11 family of standards adopted by the Institute of Electrical and Electronics Engineers (IEEE®) provides a great number of mechanisms for wireless communications between stations.

Today, the evolution of Artificial Intelligence and Machine Learning (AIML) technology is rapidly growing and getting applicable to various technology domains such as image processing, speech recognition, medical diagnosis, robotics control, automatic chatbot and so on.

Thanks to the dynamic and complex nature of the IEEE 802.11/Wi-Fi technology domain, AIML has a huge potential of improving its performance optimization such as throughput, efficiency, fairness, power consumption etc. Moreover, as the generation of the IEEE 802.11 specification evolves (i.e., 11ax, 11be, 11bn and so on), it is getting much more complex than before. For example, 802.11be introduces Multi-Link Operation with various possible configurations (e.g., EMLSR/EMLMR operation, STR/NSTR operation, NSTR mobile AP operation, etc.) from which that it is not easy to find the optimal one for a specific purpose. AIML is considered as a potential solution to tackle these complexities.

There are various use cases which may benefit from AIML optimization. They include, inter alia, Channel access, Link configuration, Frame aggregation, PHY features, MU (Multi-User) communication, Spatial reuse, Channel bonding, Multi-band (Multi-link)/network MIMO/Full-duplex, Beamforming, Channel and band selection, Traffic prediction, Management architectures and Health of Wi-Fi connections etc.

AIML in wireless networks utilize distributed data, distributed AIML models and distributed computational resources among the devices or stations connected to the network. The devices communicate each other to share those data, AIML models, computational resources to reach an optimization target depending on each use case.

As an example, publication IEEE 802.11-23-0750-00 entitled “Discussions on Neural Network Model Sharing for WLAN” focuses on a neural network (NN) model sharing where the AP trains NN models for transmission scheme optimization and shares/deploys the NN models to non-AP stations.

However, the sharing of information to achieve appropriate collaboration may be detrimental to network efficiency as a number of frames can be exchanged.

### SUMMARY OF THE INVENTION

The present invention has been devised to address one or more of the foregoing concerns. In particular, it aims at speeding up knowledge by the stations of each other about AIML, in particular about the AIML capabilities of the stations, to ease configuration and negotiation between devices using AIML technology.

In this context, the invention provides a communication method in a wireless network, comprising at a first station:
transmitting, to a second station, a management frame including artificial intelligence and machine learning, AIML, profile information defining a profile of AIML capabilities at the first station, wherein the AIML profile information is based on pre-defined AIML profiles or sub-profiles.

Reciprocally, it also provides a communication method in a wireless network, comprising at a second station:
receiving, from a first station, a management frame including artificial intelligence and machine learning, AIML, profile information defining a profile of AIML capabilities at the first station, wherein the AIML profile information is based on pre-defined AIML profiles or sub-profiles.

Reference to a pre-defined profile or sub-profile, such as an index or a bit within a bitmap, can be provided in the AIML profile information to notify the second station about the AIML capabilities of the first station. As a consequence, AIML capabilities can be exchanged between the stations of the wireless network, and appropriate data, AIML models and computational resources can be shared. AIML collaboration is thus improved for the benefit of a more efficient network.

The first station may be a non-AP (access point) station declaring its capabilities to the AP. Reversely, it may be the AP advertising all the AIML models it supports, to the non-AP stations of the BSS it manages. Correspondingly, the second station may be the AP, or alternatively any non-AP station, in particular those belonging to the BSS.

The invention also defines a first communication device in a wireless network, comprising a transmitter configured to transmit, to a second communication device of the wireless network, a management frame including artificial intelligence and machine learning, AIML, profile information defining a profile of AIML capabilities at the first communication device, wherein the AIML profile information is based on pre-defined AIML profiles or sub-profiles. Correspondingly, a second communication device in a wireless network, comprises a receiver configured to receive, from a first communication device of the wireless network, a management frame including artificial intelligence and machine learning, AIML, profile information defining a profile of AIML capabilities at the first communication device, wherein the AIML profile information is based on pre-defined AIML profiles or sub-profiles.

A non-transitory computer-readable medium is also provided that stores a program which, when executed by a microprocessor or computer system in a communication device, causes the communication device to carry out the steps of any of the methods above.

Optional features are defined below with reference to methods, while they can be transposed into device features.

In some embodiments, the AIML profile information includes a bitmap, bits of which respectively mapping to pre-defined AIML profiles. Hence, any bit enabled in the bitmap may mean the respective (or mapped) pre-defined AIML profile is supported by the first station. Alternatively, one or more mere indexes identifying one or more respective pre-defined AIML profiles can be used.

In alternative embodiments, the AIML profile information includes multiple AIML sub-profile fields corresponding to multiple parameters or sets of parameters composing an AIML profile, wherein each AIML sub-profile field of the multiple AIML sub-profile fields includes an index referencing a pre-defined AIML sub-profile for the corresponding parameter or set of parameters. An improved customization of the AIML profiles is therefore made available.

In some embodiments, the AIML profile information further includes AIML profile version information defining a set (i.e., version) of pre-defined AIML profiles or sub-profiles available. This allows the set of pre-defined profiles or sub-profiles to evolve over time (new items can be added or modified) while the stations still understand each other about their AIML capabilities. The version information can be omitted should the pre-defined profiles or sub-profiles be set once and for all.

The management frame used in the invention may be of various types. For instance, should the first station be an AP station, the management frame may be a Beacon frame or a Probe Response frame or an Authentication frame or an Association Response frame or any Action frame. Some are broadcast to all the non-AP stations of the BSS managed by the AP station, while other are unicast to specific non-AP stations. Conversely, should the first station be a non-AP station, the management frame may be Probe Request frame or an Authentication frame or an Association Request frame or any Action frame.

In some embodiments, the first station caches the AIML profile information in local memory and reuses the cached AIML profile information in a future management frame. This aims at simplifying the advertising of own AIML capabilities to other second stations. Of course, the AIML profile information may be replaced in local memory when it evolves over time for the first station.

Conversely, the second station retrieves the AIML profile information from the received management frame and locally stores the retrieved AIML profile information as part of first station's information. Therefore, there is no need to obtain again the AIML profile information for a future use (e.g., when the second station reassociates later to the same first station)

In some embodiments, the AIML profile information is included in a Reduced Neighbor Report, RNR, element or Neighbor Report, NR, element or Multi-Link element or Vendor Specific element as defined in the IEEE 802.11 family. The RNR and NR and Vendor Specific elements are for instance defined in IEEE® 802.11-2020 (part 11) and may be updated in subsequent 802.11 standards. The Multi-Link element is defined in draft IEEE P802.11be/D3.0 of March 2023. These information elements are advantageously available for insertion in the management frames listed above. Hence, existing signalling can be reused.

In other embodiments without specific information elements in the meaning of IEEE 802.11, the management frame is an Action frame (e.g., in the meaning of IEEE 802.11-2020) including a Category field, an AIML Action field and the AIML profile information. An AIML Action field set to a Request value may define an AIML Request Action frame for a non-AP station to exchange or update AIML information (capabilities) with an AP station and request the same from the AP station. An AIML Action field set to a Response value may define an AIML Response Action frame for the AP station to exchange or update AIML information (capabilities) either in an unsolicited manner or in a solicited manner (i.e., in response to an AIML Request Action frame).

In some embodiments, the first station is a first access-point, AP, station, the second station is a non-AP station, and the non-AP station:
receives, from a second AP station, a second management frame including second AIML profile information defining a profile of AIML capabilities at the second AP station,
selects one of the first and second AP stations based on the received AIML profile information and second AIML profile information, and
requests association to the selected AP station. Such request may merely be the sending of an Association Request frame to the selected AP station.

The selection of an AP station from the AP stations therefore takes into account their AIML capabilities. Such selection may be based on AIML capabilities and/or needs of the non-AP station itself. The selected AP station's AIML capabilities may match those of the non-AP station. Thanks to the AIML profile advertising according to the invention, a station may therefore choose the most appropriate AP station to associate with, given its AIML needs.

In other embodiments, the first station is a non-access-point, AP, station, the second station is an AP station, and the AP station:
decides, based on the received AIML profile information, whether to accept or refuse an association of the non-AP station to a Basic Service Set, BSS, the AP station manages, and transmits, to the non-AP station, an Association Response frame including an indication of the decided association acceptation or refusal.

The decision may be merely based on comparing whether the AIML capabilities of the non-AP station match AIML capabilities of the AP station or AIML capabilities implemented in the BSS it manages.

Of course, the AP station's decision based on the AIML profile information received from a non-AP station may be combined (e.g., may follow) the selection by the non-AP station of that AP station from multiple APs having advertised their own AIML profile information.

In some embodiments, the profile of AIML capabilities is associated with one or more predefined model groups, each defining AIML models. This leaves open the choice of a specific AIML model, e.g., suitable for a specific situation or use case, to any station after the stations are aware of reciprocal AIML capabilities.

In specific embodiments, the AIML models of the same model group have the same ML algorithm, the same input parameters, the same output parameters and the same optimization policy to train the AIML models. Model architecture between the inputs and the outputs may therefore be free from selection by the station wishing to implement such a model, e.g., regarding a number of hidden layers and hidden nodes per hidden layer in the case of neural network models.

In some specific embodiments, the first station is a first access-point, AP, station, the second station is a non-AP station, and the non-AP station:
determines a model group associated with the AIML profile information included in the management frame, (and the non-AP station also supports)
obtains an AIML model of the determined model group, and
requests AIML data to the AP station to train the obtained AIML model.

This allows the non-AP stations to obtain training data about the wireless network it cannot know, e.g., because they relate to other stations within the network. In particular, the requested AIML data may include buffer statuses of other stations in the network, to train an AIML model that drives channel access of the non-AP station.

In some embodiments, obtaining the AIML model includes requesting an AIML model for the determined model group, to the AP station. This advantageously allows the same AIML model to be spread over multiple non-AP stations registered to the AP station, to have homogeneous behaviour of the non-AP stations. Indeed, the AP station has its own fixed location and thus has good knowledge of the wireless environment around it. Such an AIML model built based on such known wireless environment can therefore be provided to new non-AP stations joining the BSS.

According to some implementations, the requested AIML model is a pre-trained AIML model. This allows the AP station to take advantage of its richer resources (compared to the non-AP stations) to train the AIML model e.g., to work well given its wireless environment.

In a variant, the non-AP station may select a locally-available AIML model of the determined model group.

In some embodiments, the non-AP station shares an updated AIML model resulting from a training of the obtained AIML model, with the AP station. This contributes to obtain dynamic (and thus up-to-date) AIML collaboration for AIML models driving use of the network. Network efficiency is therefore improved.

In some embodiments, the updated AIML model forms part of a global AIML model managed by the AP station, and the non-AP station receives, in response to the sharing, an updated global AIML model. Typically, the global AIML model integrates one or more local AIML models collected from one or more non-AP stations. This approach ensures the same (updated) optimization is spread over the entire network, hence further improving network efficiency.

In some embodiments, the profile of AIML capabilities defines one or more use cases that correspond to one or more communication mechanisms in which an AIML model complying with the AIML capabilities is to be used. Exemplary use cases have been recalled above. Pre-defined AIML profiles can therefore target specific purposes, hence speeding up any agreement on shared AIML models within the network.

At least parts of the methods according to the invention may be computer implemented. Accordingly, the present invention may take the form of an entire hardware embodiment, an entire software embodiment (including firmware, resident software, microcode, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer-readable code for provision to a programmable apparatus on any suitable carrier medium. A tangible carrier medium may comprise a storage medium such as a floppy disk, a CD-ROM, a hard disk drive, a magnetic tape device or a solid-state memory device and the like. A transient carrier medium may include a signal such as an electrical signal, an electronic signal, an optical signal, an acoustic signal, a magnetic signal or an electromagnetic signal, e.g., a microwave or RF signal.

### BRIEF DESCRIPTION OF THE DRAWINGS

Some embodiments of the present invention are illustrated by way of example, and not by way of limitation, in the figures of the accompanying drawings, in which like reference numerals refer to similar elements and in which:

FIG. 1 illustrates an example of a network system in which some embodiments of the invention may be implemented;

FIG. 2 illustrates an example of Profile table for AIML which pre-defines a mapping between AIML Profiles and supporting AIML capabilities;

FIGS. 3a and 3b illustrate, using flowcharts, general steps performed at station (including both AP stations and non-AP stations) to exchange AIML capabilities using managements;

FIG. 4 illustrates exemplary information element formats to signal AIML profile information according to some embodiments of the invention;

FIG. 5 illustrates exemplary Action frame formats to exchange AIML profile information according to some embodiments of the invention;

FIG. 6 illustrates a sequence of management frame exchange in which AIML profile information is exchanged between a non-AP station and an AP station, according to some embodiments of the invention;

FIG. 7 illustrates another exemplary sequence of management frame exchange involving multiple AP stations, according to some embodiments of the invention;

FIG. 8 illustrates an example of deep neural network architecture to operate an AIML operation, according to some embodiments of the invention;

FIG. 9 illustrates an example of model groups table that defines AIML model parameters for the AIML profiles, according to some embodiments of the invention;

FIG. 10 illustrates an exemplary frame sequence to exchange data or AIML models, according to some embodiments of the invention;

FIG. 11 illustrates an exemplary table of values for an Action field in an AIML Action frame, according to some embodiments of the invention;

FIG. 12 illustrates exemplary Action frame formats to exchange data or AIML models, according to some embodiments of the invention; and

FIG. 13 illustrates an example of a communication device of a wireless network, configured to implement at least one embodiment of the present invention.

### DETAILED DESCRIPTION OF THE INVENTION

The present invention concerns the advertisement of AIML capabilities between stations of a wireless network. AIML stands for “Artificial Intelligence and Machine Learning”. AIML technology regards AI-based mechanisms that can be implemented to drive communication features or mechanisms within the network.

Depending on the targeted communication features, plenty of use cases can benefit from AIML optimization, including Channel access, Link configuration, Frame aggregation, PHY features, MU (Multi-User) communication, Spatial reuse, Channel bonding, Multi-band (Multi-link)/network MIMO/Full-duplex, Beamforming, Channel and band selection, Traffic prediction, Management architectures, Health of Wi-Fi connections, Device level power consumption, CSI compression and feedback, and so on.

Collaborative approach in the AIML technology is contemplated so that the stations share their data and models.

Publication IEEE 802.11-23-0750-00 entitled “Discussions on Neural Network Model Sharing for WLAN” discusses some general considerations on neural network sharing for WLANs where the AP trains NN models and shares/deploys the NN models to non-AP stations. Most use cases such as device level power consumption, non-AP spatial reuse, distributed channel access, link adaptation and beam management are categorized as transmission scheme optimization.

The NN model architecture of such transmission scheme use cases is discussed, including inputs from wireless radio measurements (e.g., MAC/PHY measurements), pre-processing (e.g., format conversion and feature extraction), core neural network model (e.g., structure, layer type, number of layers and of neurons per layer), and post-processing (e.g., map neural network output to specific transmission scheme).

Various AIML approaches/algorithms exist to solve wireless optimization problems. For example, ML (machine learning) techniques are generally categorized into three learning approaches, namely Supervised Learning, Unsupervised Learning and Reinforcement Learning. Nowadays, two or all of these approaches can be combined into an advanced (or enhanced) approach, to reach the system requirements. Furthermore, each learning approach has its own variations of algorithms. For example, multiple Reinforcement Learning algorithms exist such as Q-learning, DQN (Deep Q-Network), DDPG (Deep Deterministic Policy Gradient), A3C (Asynchronous Advantage Actor-Critic) etc. On top of that, each algorithm has its own (and sometimes numerous) parameters. For example, for a Neural-Network-based algorithm, NN architecture parameters are required such as a number of layers, a number of neurons in each layer, connections between the neurons of the layers, a type of activation function, and so on.

Given the resulting wide variety of AIML options the stations (communication devices) have, it is expected that not all the stations can support the same use cases, AIML models, algorithms and parameters.

A need therefore exist for the stations to exchange their AIML capabilities as early as possible to quickly agree on efficient mechanisms to optimize network communications. As described in the embodiments below, a management frame can be sent by a first station or communication device to advice a second station, which management frame includes AIML profile information defining a profile of AIML capabilities at the first station. To ease configuration at the stations and negotiation between them, the AIML profile information is based on pre-defined AIML profiles or sub-profiles. A pre-defined AIML profile may for example be signalled using a dedicated index.

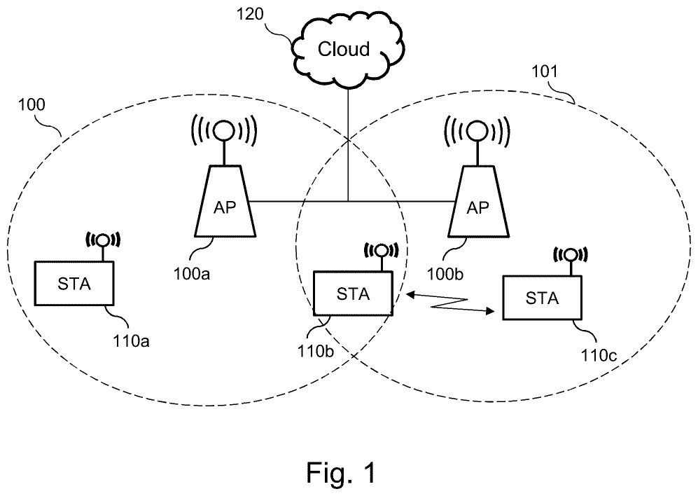

FIG. 1 illustrates an example of a network system in which some embodiments of the invention may be implemented.

For the sake of illustration, FIG. 1 represents an 802.11 network (i.e., a Wi-Fi network) system 100 comprising three wireless devices: an access point station (AP) 100a and two non-AP stations (non-AP STAs) 110a, and 110b. Of course, the number of non-AP stations 110a and 110b may be different from two. AP station 100a provides wireless connections between non-AP stations 110a and 110b and/or to a wider network, such as the Internet (e.g., access to the Cloud 120). The connection of one of non-AP stations 110a and 110b to AP station 100a may be performed by a standardized process called association. Once a non-AP station is associated with the AP station, the non-AP station can send data to the network and receive data from the network through the AP station.

System 101 is another 802.11 network system comprising two wireless devices: AP station 100b and non-AP station 110c. Again, another number of stations in system 101 can be contemplated.

In a scenario, non-AP station 110b is within the range of both AP stations 100a and 100b.

The network system may also host peer-to-peer (P2P) exchanges where two non-AP stations, e.g., non-AP stations 110b and 110c, directly exchange frames without involving the AP stations.

AP stations 100a and 100b may comprise, be implemented as, or known as a Node B, Radio Network Controller (RNC), evolved Node B (eNB), 5G Next generation base station (gNB), Base Station Controller (BSC), Base Transceiver Station (BTS), Base Station (BS), Transceiver Function (TF), Radio Router, Radio Transceiver, Basic Service Set (BSS), Extended Service Set (ESS), Radio Base Station (RBS), or some other terminology. It can be a standalone product or it may be integrated in a device, for instance in a broadband remote access server (BRAS).

Non-AP stations 110a, 110b and/or 110c may comprise, be implemented as, or known as a subscriber station, a subscriber unit, a mobile station (MS), a remote station, a remote terminal, a user terminal (UT), a user agent, a user device, a user equipment (UE), a user station (STA), or some other terminology. In some implementations, a non-AP station may be or may comprise a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or a smartphone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, some of non-AP stations 110a, 110b, and 110c may be wireless nodes. Such a wireless node may provide, for example, connectivity for or to a network (e.g., a wide area network such as the Internet or a cellular network) via a wired or wireless communication link.

Each of AP stations 100a and 100b manages a set of stations that together organize their accesses to the wireless medium for communication purposes. All the stations managed under a given AP station (AP station 100a and non-AP stations 110a, 110b, or AP station 100b and non-AP station 110b, 110c) form a service set, which may be referred to as a basic service set, BSS (although other terminology can be used). It is noted that AP stations 100a and 100b may manage more than one BSS: each BSS is thus uniquely identified by a specific basic service set identifier (BSSID) and managed by a separate virtual AP station implemented in physical AP stations 100a and 100b.

Cloud 120 may comprise, be implemented as, or known as a cloud server, a MEC (Multi-access Edge Computing/Mobile Edge Computing) server and/or a network controller. Cloud 120 and AP stations 100a and 100b can be connected via any kind of wired or wireless network.

To advertise AIML capabilities between the stations, AIML profiles are defined that are known by the stations (either within a BSS or throughout the BSSs).

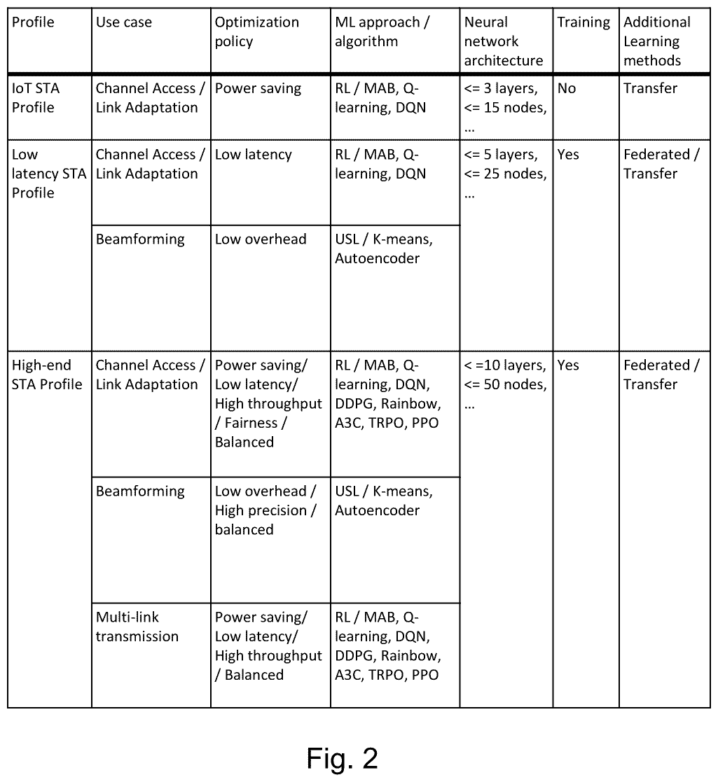

FIG. 2 illustrates an example of Profile table for AIML (called AIML profile table hereafter) which pre-defines a mapping between each AIML profile and corresponding supported capabilities. These capabilities (or AIML capabilities) mirror features that a supporting station can implement to perform AIML mechanisms.

The AIML profile table is predefined by any means (e.g., as an international standard, as a consensus among a group of devices, such as a BSS) and all the stations supporting the profile communication for AIML are able to understand the mapping between each profile and its supported capabilities.

For example, as illustrated in the Figure, three AIML profiles are defined, namely IoT STA Profile, Low latency STA Profile and High-end STA Profile. For each profile, a list of capabilities is defined such as supported use cases, optimization policies, ML approaches/algorithms, neural network parameters, training and Additional learning methods, etc. Other parameters or capabilities than those shown may be added.

Indicating supporting one or more of the AIML profiles means that the advertising station is capable of supporting all the capability features listed in the corresponding rows of the indicated AIML profiles, in the AIML profile table.

“Use case” column indicates for which use cases the AIML profile can be used. This defines specific areas of communication mechanisms in which an optimization by AIML complying with the AIML profile can be performed. In the examples of the Figure, use cases of the proposed AIML profiles include Channel Access, Link Adaptation, Beamforming, Multi-Link transmission.

“Optimization policy” column indicates the optimization policy or policies the AIML profile supports for the corresponding use case. In other words, it indicates the communication features in the Use Case mechanism(s), that can be driven in the supporting station using the AIML profile (i.e., the other indicated capabilities). For example, Power saving optimization policy for Channel Access use case enables the optimization of low power consumption during the channel access procedure.

The other columns define supported parameters for the AIML models, namely parameters related to the ML approach or algorithm, related to NN architecture (in case of neural network solution), related to training and related to additional learning methods.

AIML models compatible with the use case and optimization policy set are trained by any means or can be trained further to follow the optimization policy.

In the examples of the Figure, if a station advertises it supports IoT STA Profile, the station must support channel access and link adaptation use cases with power saving optimization policy using RL approach with MAB (Multi-Armed Bandit), Q-learning and DON (Deep Q-Network) algorithms (fourth column). Furthermore, when using deep neural network algorithms (in this case only DQN), the station device must support up to 3 layers, 15 nodes as neural network architecture (fifth column). In addition, the station does not support AIML model training function (sixth column). This means, for instance, AIML model training has to be done in other place or the station installs at least one of pre-trained models.

“Additional learning methods” column indicates what kind of additional learning methods the station supports. In the examples of the Figure, Transfer learning and Federated learning are proposed as additional learning methods. Transfer learning may mean that AIML models compatible with the AIML profile can be created (and trained) in another place and then can be sent and deployed into the supporting station. It may also mean that the station is also ready to transfer the corresponding model. Federated learning may mean that AIML models compatible with the AIML profile can be trained in a distributed manner, i.e., involving a plurality of stations. A global AIML model may integrate (or be formed of) multiple local AIML models, each being separately trained and updated by a respective station. The locally trained AIML models are then gathered in a central node (e.g., AP stations 100a or 100b or Cloud 120) to update the global AIML model. The updated global AIML model can next be fed back to each distributed stations (e.g., non-AP stations 110a, 110b and 110c).

Of course, the columns may be adapted depending on the various AIML capabilities that are defined. For example, in the Figure, only a single set of NN parameters is provided in the “Neural network architecture” column. However, for Actor-Critic algorithms such as DDPG, two different networks are required: Actor network and Critic network included in the algorithm. In this case, the column may include separate parameters for each network. Furthermore, restriction of supported activation functions or supported connection architecture (e.g., full-connection only or not) can be also predefined in the columns. Neural network architecture information is not limited to those described above and shown in the Figure, and any other relevant information can be predefined within each AIML profile.

The AIML profile table defining a set of predefined AIML profiles may be provided with a versioning number. This is because there may be multiple versions over time in which case the versioning numbers are successively incremented by 1. Preferably, a new version of the table is built to have backward compatibility with previous ones, to ensure the support of old versions. For example, the AIML profile table shown in FIG. 2 is assigned version 0, as an initial table. Such version is referred below to as “AIML profile version”.

As shown in the Figure, the AIML capabilities of the AIML profiles are explicitly listed in the rows. To provide better customization ability, each of the AIML capabilities may be defined through AIML sub-profiles: sub-profiles are predefined for each AIML capability (or parameter) as listed in the top row of the Figure. Next, any AIML profile can be built by selecting one sub-profile for each or any of these AIML capabilities/parameters.

For example, the “Use Case” capability (second column) of an AIML Profile may be defined though one or more indexes corresponding to one or more predefined “use case” sub-profiles from amongst the following set of predefined sub-profiles: sub-profile 1: Channel Access, Link Adaptation; sub-profile 2: Channel Access, Link Adaptation, Beamforming; sub-profile 3: Multi-Link transmission; and so on.

Similarly, the “ML approach/algorithm” capability (fourth column) of an AIML Profile may be defined though one or more indexes corresponding to one or more predefined “ML approach/algorithm” sub-profiles from amongst the following set of predefined sub-profiles: sub-profile 1: RL (Reinforcement Learning)/MAB, Q-learning, DQN; sub-profile 2: RL/MAB, Q-learning, DON, USL (Unsupervised Learning)/K-means, Autoencoder; and so on.

In the example shown, the customized IoT STA Profile may be defined using sub-profile 1 as “Use Case” sub-profile and sub-profile 1 as “ML approach/algorithm” sub-profile and all other appropriate sub-profiles as well.

The predefined AIML profiles thus defined, such as those shown in FIG. 2, are used by the stations of the networks 100 and 101 to exchange or advertise their AIML capabilities, i.e., their ability to use some AIML models for specific use cases.

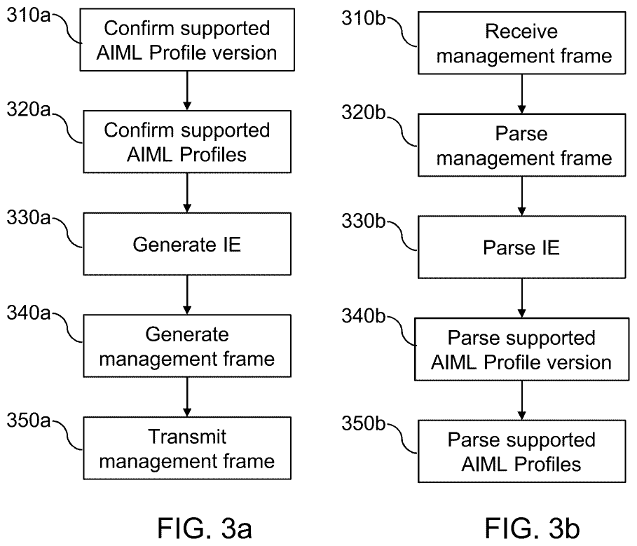

FIGS. 3a and 3b illustrate, using flowcharts, general steps performed at stations (including both AP stations and non-AP stations) to exchange such AIML capabilities through the signalling of one or more predefined AIML profiles in management frames. FIG. 3a illustrates the steps at a first station transmitting such management frame, while FIG. 3b illustrates the steps at a second station receiving the transmitted frame.

In this respect, the management frame includes AIML profile information defining a profile of AIML capabilities at the transmitting station, the AIML profile information being based on the pre-defined AIML profiles or sub-profiles. The AIML profile information may further include AIML profile version information defining a set (i.e., version) of pre-defined AIML profiles or sub-profiles available (e.g., those profiles shown in FIG. 2).

Of course, as the stations exchange their AIML capabilities, the same station may both transmit its own AIML capabilities and receive AIML capabilities from one or more other stations. It means the same station can perform both processes of FIGS. 3a and 3b.

It comes that the station performing either process can be alternatively a non-AP station or an AP station.

Management frames transmitted by an AP station include Beacon frames, Probe Response frames, Authentication frames, Association Response frames and Action frames. These frames are received by non-AP stations. Some of these frames (e.g., Beacon frames) are broadcast in the wireless network, while other frames (e.g., Association Response frames) are unicast to specific non-AP stations.

Management frames transmitted by a non-AP station include Probe Request frames, Authentication frames, Association Request frames and Action frames. In a BSS scenario, these frames are addressed to, and thus received by, AP stations. In a peer-to-peer (P2P) scenario, the management frames are exchanged between two non-AP stations, hence they are addressed to, and thus received by, a non-AP station.

Any one of these exemplary management frames may include AIML profile information in the context of the invention, although not all of these frames necessary include the AIML profile information. For example, Authentication frames and/or not all Action frames may not include the AIML profile information.

Any event at a station may trigger the process of FIG. 3a to start the advertisement of its AIML capabilities to other stations. As examples, an AP station may advertise its AIML capabilities in each Beacon frame. A non-AP station may advertise its AIML capabilities when joining a BSS, i.e., when associating to an AP station. Any station may decide to advertise its own AIML capabilities each time the latter change.

At step 310a, a first station wishing to advertise its AIML capabilities confirms which AIML profile version(s) it supports. This step is optional if only one version is available for the stations. At step 320a, the first station confirms which AIML profile(s) it supports. For example, the first station traverses all the predefined AIML profiles (as e.g., shown in FIG. 2 or any up-to-date AIML profile table) and determines which ones match its own AIML capabilities. Optionally, the first station may decide to advertise only some of those matching AIML profiles for any reason, in which case the first station selects some of them. When the AIML profiles to advertise are known as well as the optional AIML profile version, step 330a consists for the first station to generate AIML profile information based on the optional AIML profile version and the AIML profile or profiles to advertise, as acquired in the previous steps.

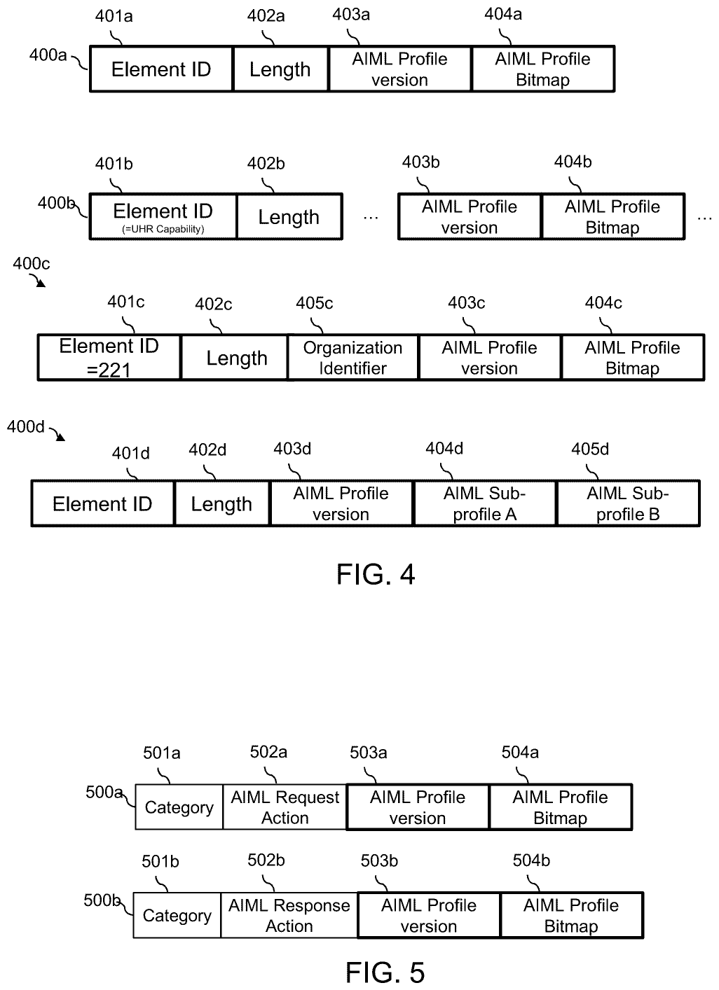

Exemplary formats to signal the AIML profile information are shown in FIG. 4. The Figure depicts four examples 400a, 400b, 400c and 400d of AIML profile information signalling using information elements in the meaning of the IEEE802.11 family of standards.

The order of the subfields can be changed and any other subfield not illustrated in the Figure may be additionally included, preferably as long as it follows the information element format rule specified in the IEEE 802.11 specification.

Example 400a is a new information element (IE) dedicated to AIML profile information. IE 400a consists of Element ID 401a, Length 402a, optional AIML profile version 403a and AIML profile Bitmap 404a. Optional AIML profile version 403a can be omitted. Any other field may be added without departing from the scope of the invention. Element ID 401a may take any value (e.g., 254) reserved in the latest IEEE 802.11 specifications. Length 402a indicates the number of octets in the IE excluding Element ID and Length fields 401a, 402a. AIML Profile version 403a, when present, indicates the supported version of the AIML profiles. For example, value 0 in the AIML Profile version field 403a may indicate the AIML profile table of FIG. 2 applies. AIML Profile Bitmap 404a consists of a bitmap where all supported AIML profiles as obtained at step 320a (for the optionally indicated AIML profile version) is mapped to each bit. In that case, the AIML profile information includes a bitmap, bits of which respectively mapping to pre-defined AIML profiles.

As an example, for AIML profile version 0 corresponding to FIG. 2, IoT STA Profile, Low latency STA Profile, High-end STA Profile are mapped to the 1^{st}, 2^{nd} and 3^{rd} bits respectively of AIML Profile Bitmap 404a. It means that if the first station supports all three profiles, it enables the 1^{st}, 2^{nd} and 3^{rd} bits (bits set to 1) in AIML Profile Bitmap 404a. However, if the first station only supports IoT STA Profile, it enables only the 1^{st} bit (bit set to 1) and disables the 2^{nd} and 3^{rd} bits (bits set to 0) in AIML Profile Bitmap 404a.

Example 400b illustrates an IE dedicated to other purpose (i.e., already having some fields) that is enhanced with a first optional additional field 403b to contain the AIML Profile version information and a second additional field 404b to contain the AIML Profile Bitmap (as described above). The IE may be an already-existing IE such as a Reduced Neighbor Report, RNR, element or a Neighbor Report, NR, element or a Multi-Link element as defined in the IEEE 802.11 family, that is enhanced with the one or two additional fields. This allows the first station to advertise about the supported AIML Profiles while reporting other information. Alternatively, the IE may be a new IE to come for new IEEE issues, e.g., an UHR (Ultra High Reliability) capability element which is to be defined in the future 802.11bn amendment. Of course, UHR capability element is only an example. Element ID 401b still identifies the IE concerned. Fields 402b to 404b are identical to those 402a to 404a described above.

Example 400c is based on Vendor Specific element as defined in the IEEE 802.11 family wherein the Vendor-Specific Content field is designed to contain AIML Profile version 404c (optional) and AIML Profile Bitmap 404c. Element ID 401c is set to “221” to identify a Vendor Specific element. Organization Identifier 405c (required in this IE) is used to indicate the entity that has defined the content of this particular Vendor Specific element. The Organization Identifier field contains a public unique identifier assigned by the IEEE Registration Authority as a 24-bit OUI, a 24-bit CID, or a 36-bit OUI-36. In the present invention, a new organization may be registered for this Vendor Specific element which includes AIML profile version (optional) and the selected AIML profiles. Alternatively, an existing organization identifier may be reused. Fields 402c to 404c are identical to those of 402a to 404a.

All these exemplary signalling are based on an AIML Profile Bitmap, the bits of which map the predefined AIML profiles (such as those of FIG. 2). Alternatively, the signalling may use predefined sub-profiles as defined above to indicate each AIML capability (or parameter), e.g., those as listed in the top row of the FIG. 2. In this approach, the signalling includes multiple AIML sub-profile fields corresponding to multiple parameters or sets of parameters composing an AIML profile. Each AIML sub-profile field of the multiple AIML sub-profile fields includes an index referencing a pre-defined AIML sub-profile for the corresponding parameter or set of parameters. This provides extended customizability of the AIML Profiles.

Corresponding exemplary signalling is shown in example 400d. A number of AIML sub-profile fields is provided (AIML sub-profile A field 404d, AIML sub-profile B field 405d, and so on), corresponding to each and every AIML capability or parameter to be defined. For example, one AIML sub-profile field may be provided for each column of columns 2 to 7 of FIG. 2. Each AIML sub-profile field contains the index corresponding of the sub-profile to be signalled. For example, AIML “Use Case” sub-profile field (for column 2 in FIG. 2) can be set to “1” to signal “Channel Access, Link Adaptation”, while AIML “ML approach/algorithm” sub-profile field (for column 3 in FIG. 2) can be set to “2” to signal “RL/MAB, Q-learning, DQN, USL (Unsupervised Learning)/K-means, Autoencoder”.

The size of AIML Profile version field 403 may be one octet as an example but not restricted to that value. The size of AIML Profile Bitmap field 404a/b/c and AIML Sub-profile fields 404d/405d may depend on the AIML profile version and it may be one octet as an example but not restricted to that value.

Described step 330a can be omitted when the AIML Profile information (AIML Profile version and AIML profiles) is not signalled in an information element. Indeed, alternatively to the use of information elements, the AIML Profile information may be directly included in the management frame, in particular in an Action frame as described below with reference to FIG. 5, as new fields.

Therefore, at step 340a, the first station generates a management frame that includes the AIML Profile information.

It may merely consist in including the information element generated at step 330a in the management frame. Alternatively, optional AIML profile version field (such as 403a/b/c/d described above) and AIML profile Bitmap field (404a/b/c) or AIML Sub-profile fields (404d/405d) are directly included in the management frame.

FIG. 5 illustrates exemplary Action frame formats to exchange AIML profile information according to some embodiments of the invention. As mentioned above, Action frames may be used as management frames to exchange and/or update AIML version (optional) and supported AIML profiles.

500a and 500b illustrate an AIML Profile Request Action Frame format and an AIML Profile Response Action Frame format respectively. The AIML Profile Response Action Frame may be transmitted in a solicited manner, i.e., as a response to the AIML Profile Request Action Frame. Any of an AP station and a non-AP station may send the request while the other sends the response.

Alternatively, the AIML Profile Response Action Frame may be transmitted in an unsolicited manner, i.e., without receiving previous AIML Profile Request Action Frame.

As shown in the Figures, the Action frames include a Category field, an AIML Action field and the AIML profile information.

Category subfield 501a and 501b may have a new value dedicated to a new “AIML” category. Any value (e.g., 125) reserved in the latest IEEE 802.11 specification can be used. AIML Action subfield 502a and 502b indicates the subtypes of the AIML action: AIML Request Action (e.g., by setting field 502a to 0) and AIML Response Action (e.g., by setting field 502b to 1). AIML profile information is signalled in AIML Profile version field 503a, 503b (for optional AIML Profile version) and AIML Profile Bitmap field 504a, 504b (for the supported AIML Profiles), as already described above with reference to fields 403a and 404a respectively.

As above, multiple AIML Sub-profile fields 404d, 405d can be used alternatively to the AIML Profile Bitmap, in the Action frames. Also, the order of fields depicted in FIG. 5 can be changed and any other subfields not illustrated in the Figure such as a Dialog Token subfield or a Status Code subfield may be additionally included. Preferably, the resulting format follows at least the Action frame format rule specified in the IEEE 802.11-2020 specification.

Back to FIG. 3a, once the management frame has been built at step 340a (either as a frame including directly the AIML Profile information or through an IE), the first station transmits, at step 350a, the management frame to at least one second station. It may be a single station if the management frame is a unicast frame, or multiple stations if the management frame is a broadcast frame.

In that way, the second station or stations may become aware of the AIML Profiles the first station supports, hence be aware of the first station's AIML capabilities.

Since the AIML Profile supported by the first station do not change dynamically, steps 310a, 320a and 330a may be performed only once, in which case the generated AIML Profile information (e.g., in the format of an information element 400a) may be cached and reused for the future management frames. In other words, the first station caches the AIML profile information in local memory and reuses the cached AIML profile information in a future management frame.

Correspondingly, when the first station's AIML capabilities change, the AIML Profile information can be updated. In that case, these steps can be performed again from the beginning.

Turning now to any second station addressee of the management frame, the second station receives, at step 310b shown in FIG. 3b, such management frame from the first station.

At step 320b, the second station parses the received management frame and extracts the information element 400a/b/c/d, if any, which includes the AIML Profile information (FIG. 4) or extracts directly the AIML Profile information from the received frame (e.g., in the case of the Action frames of FIG. 5).

At step 330b, the second station parses the extracted information element 400a/b/c/d and extracts the AIML Profile version field 403a/b/c/d and the AIML Profile field (either AIML Profile Bitmap 404a/b/c or AIML Sub-profile fields 404d, 405d). Extracting the AIML Profile version field may be optional if only one version is defined as an AIML Profile version.

If no information element 400a/b/c/d is used, step 320b can be omitted and step 330b directly parses and extracts the AIML Profile version field 503a/b and the AIML Profile field (either AIML Profile Bitmap 504a/b or AIML Sub-profile fields).

At step 340b, the second station parses the AIML Profile version field so extracted and confirms which AIML Profile version the first station supports. Step 340b is optional if only one version is defined as an AIML Profile version.

Next, at step 350b, the second station parses the AIML Profile field extracted at step 330b and confirms which AIML Profile or Profiles the first station supports. For example, the second station reads each bit in extracted AIML Profile Bitmap 404a/b/c and considers each AIML Profile corresponding to a bit equal to 1 as being supported by the first station.

Since the AIML profile supported by the first station do not change dynamically, steps 330b, 340b and 350b may be performed only once, in which case the confirmed AIML Profile version and the AIML Profiles may be stored as a part of first station's information locally stored at the second station. In other words, the second station retrieves the AIML profile information from the received management frame and locally stores the retrieved AIML profile information as part of first station's information.

Steps 330b, 340b and 350b of FIG. 3b may be performed only for specific management frames that are dedicated for AIML profile information announcement (i.e., they convey the AIML Profile information). For illustrative purposes, Association Request/Response frames and Action frames can be used for such announcement.

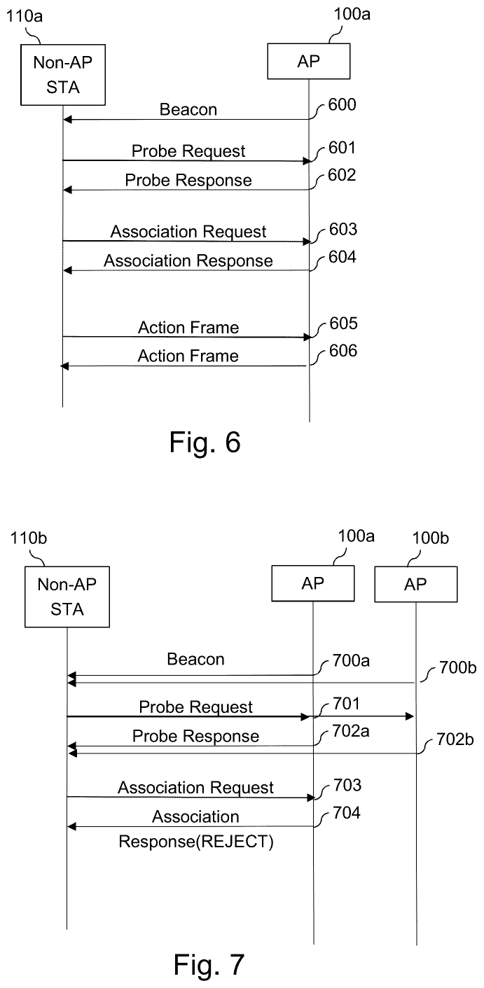

FIG. 6 illustrates a sequence of management frame exchange between non-AP station 110a and an AP station 100a, for example for the former to register or associate to the latter. Such frame exchange may be used to operate an AIML Profile communication procedure, according to some embodiments of the invention.

AP station 100a transmits Beacon 600 periodically (in general at every 100 msec interval). Non-AP station 110a transmits Probe Request frame 601 to scan AP stations in its vicinity. If AP 100a succeeds to receive this Probe Request frame 601, it replies with Probe Response frame 602. If non-AP station 110a decides to associate with AP station 100a, it performs an Authentication frame exchange (not illustrated) and then transmits Association Request frame 603 to AP station 100a. If AP 100a agrees with the association requested in received Association Request frame 603, it replies with Association Response frame 604. Association is established when Association Response including a status code SUCCESS(0) is correctly received by non-AP station 110a. After the association, AP station 100a and non-AP station 110a may exchange Action frames 605 and/or 606.

In embodiments of the invention, the AIML Profile information (the optional AIML Profile version and the AIML Profiles) may be exchanged between AP station 100a and non-AP station 110a using any of these management frames. Any signalling using the IEs of FIG. 4 or the frame formats of FIG. 5 can be used.

The AIML Profile information exchanged or advertised in a previous management frame can be updated by a new AIML Profile information signalled in a subsequent management frame exchange.

FIG. 7 illustrates another exemplary sequence of management frame exchange involving multiple AP stations (here two 100a and 100b), still in the process for non-AP station 110b to register to an AP station. Such frame exchange may be used to illustrate how non-AP station 110b can use the AIML Profile communication procedure according to some embodiments of the invention to select an AP station for registration, and how an AP station can use the AIML Profile communication procedure to accept or refuse an association request from a non-AP station.

In this scenario, non-AP station 110b is within the range of both AP stations 100a and 100b. In this case, non-AP station 110b can exchange management frames between both AP stations. Of course, more than two AP stations may be involved and exchange management frames with the same non-AP station.

Beacons 700a and 700b sent by AP station 100a and AP station 100b respectively are received by non-AP STA 110b. Probe Request frame 701 transmitted by non-AP station 110b is received by both AP stations 100a and 100b. Next, both AP stations 100a and 100b respond to non-AP station 110b with Probe Response frames 702a and 702b respectively.

Non-AP station 110b performs the steps of FIG. 3b when receiving Beacon frames 700a/b and/or Probe Response frames 702a/b. With the steps, non-AP station 110b becomes aware of the AIML Profile or Profiles each AP station 100a, 100b supports, given the AIML profile information they indicate. Non-AP station 110b may have a preference to associate with an AP station having particular AIML capabilities, i.e., supporting a particular AIML Profile. Therefore, based on these AIML Profiles supported by each AP station, non-AP station 110b may decide to associate with AP station 100a rather than AP station 100b (e.g., AP station 100a supports the same AIML Profile as non-AP station 110b, while AP station 100b does not).

In that case, the non-AP station:
receives, from at least two AP stations, at least two management frame each including AIML profile information defining a profile of AIML capabilities at the respective AP station,
selects one of the AP stations based on the received AIML profile information from the AP stations, and
requests association to the selected AP station. As shown in the Figure, non-AP station 110b sends Association Request frame 703 to AP station 100a.

The Association Request frame 703 may include AIML Profile information of non-AP station 110b, hence providing knowledge of non-AP station's AIML capabilities to AP station 100a.

AP station 100a thus also perform the steps of FIG. 3b when receiving Probe Request frame 701 and/or Association Request frame 703 from non-AP station 110b. With the steps, AP station 100a becomes aware of the AIML Profile or Profiles non-AP station 110b supports. Based on the supported AIML Profile or Profiles, AP station 100a may decide to reject (or accept) the association by responding with an Association Response frame 704 having a status code meaning rejection. In other words, the AP station:
decides, based on the received AIML profile information, whether to accept or refuse an association of the non-AP station to a BSS the AP station manages, and
transmits, to the non-AP station, an Association Response frame including an indication of the decided association acceptation or refusal.

A new status code may be defined to indicate the reason of rejection clearly. For example, REJECTED_AIML_NOT_SUPPORTED (65535) may be defined. This status code means the AIML Profile or Profiles that are required by non-AP station 110b are not supported by AP station 100a or not accepted by it (for any network management reason). Of course, any other value than 65535 (except those already defined in the latest 802.11 specifications) can be used as Status code rejecting the association for AIML Profile not supported. Non-AP station 110b can therefore be aware of the detailed reason of the rejection, thanks to this status code.

The above description shows how stations exchange their supported AIML capabilities, helping for instance a non-AP station to select an appropriate AP station for registration or an AP station to refuse the association for a not appropriate non-AP station.

In operation, those stations can then implement AIML models conforming to their supported AIML capabilities, to drive some communication features or mechanisms (AIML operation) within the network, e.g., transmission scheme optimization.

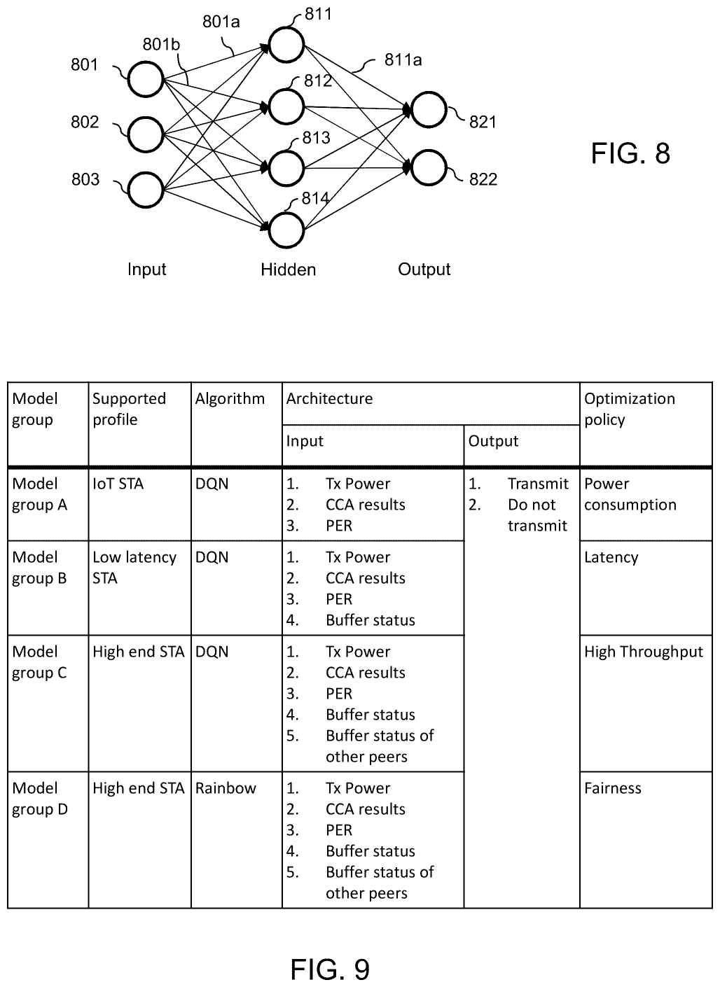

FIG. 8 illustrates an example of deep neural network architecture to operate an AIML operation, according to some embodiments of the invention. Deep neural network is used in various ML algorithms such as DQN and DDPG. Deep neural network consists of at least three layers; one input layer, one or more hidden layers and one output layer. Each layer consists of at least one node. Between two layers, various connection patterns are allowed: fully connected with every node in one layer connecting to every node in the next layer (as in FIG. 8); sparsely connected with a reduced number of connexions compared to the fully connected pattern; pooling pattern; recurrent pattern.

In the example of the Figure, three nodes 801˜803 form the input layer. Four nodes 811˜814 form the first hidden layer. Two nodes 821 and 822 form the output layer. Each connection such as 801a, 801b, 811a and others have their own weight as a parameter of the neural network, that is learnt by the training procedure.

The inputs may be obtained by pre-processing data obtained from other stations and/or by pre-processing local data such as MAC/PHY measurements. Similarly, the outputs may be post-processed to map them to specific AIML operation parameters (e.g., transmission scheme parameters, such as contention parameters).

FIG. 9 illustrates an example of model groups table that defines AIML model parameters for the AIML profiles. As these parameters for an AIML profile allow multiple variants of AIML models to be implemented, each entry is referred to as “model group”.

The example of the Figure may be used to form AIML models to operate a channel access use case AIML optimization according to some embodiments of the invention.

The model groups table may be pre-defined by any means (e.g., as an international standard, as a consensus among a group of stations) and all the stations who support the corresponding AIML profiles as shown in the “Supported profile” column are able to understand and utilize (train the model if training is supported and/or make inference/decision) the AIML models from the model group as shown in the “Model group” column in the corresponding row. For example, the stations which support the IoT STA Profile understand and utilize the AIML models from model group A and the stations which supports the High-end STA Profile understand and utilize the AIML models from model groups C and D.

In this example, all AIML models in the same model group are based on the same ML algorithm as shown in the “Algorithm” column, use the same input node parameters as in the order of the “Input” column, and use the same output node parameters as in the order of the “Output” column.

The number of hidden layers and/or the number of hidden nodes may differ among AIML models, as long as they meet the requirements of the “Neural network parameters” column of the AIML Profile table (e.g., the one shown in FIG. 2) for the relevant AIML Profile. For example, AIML models in model group A can have up to 3 layers and 15 nodes to be compliant as AIML models for the IoT STA Profile (first row in FIG. 2). Models in model group B can have up to 5 layers and 25 nodes to be compliant as AIML models for the Low latency Profile.

The “Architecture” column including “Input” and “Output” sub-columns can have other variations. For example, for Actor-Critic algorithms such as DDPG, there are two different networks, namely Actor network and Critic network, so the “Input” and “Output” sub-columns can have two lists for both “Input” and “Output”.

“Optimization policy” column corresponds to the optimization policy (i.e., the reward function in RL algorithms or the policy used to collect the training data in SL (Supervised Learning) algorithms) the model is trained with. It can be empty for USL algorithms.

This pre-defined model groups table enables the stations (including AP stations and non-AP stations) to have knowledge of model groups they support, by only exchanging their supported AIML Profiles as described above. Indeed, in this table, the profiles of AIML capabilities (AIML Profiles) are each associated with one or more predefined model groups, each defining AIML models.

There may be any other forms of parameters depending on the specific algorithm. Pre-defined information to make the AIML models work between two different stations is not limited to be included in this table.

The stations can share data (e.g., training data) and/or any AIML model. This contributes to a collaborative AIML mechanism.

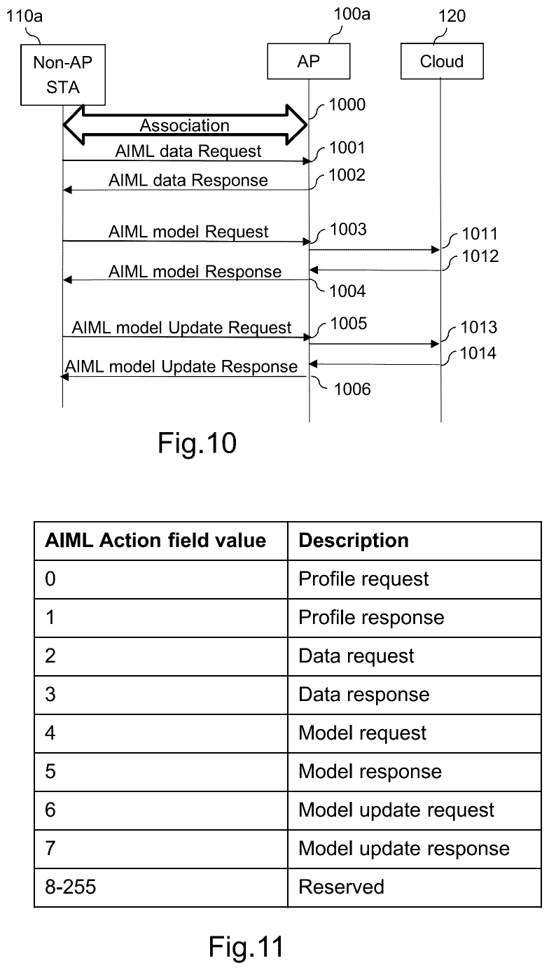

FIG. 10 illustrates an exemplary frame sequence to exchange data or AIML model according to some embodiments of the invention.

For ease of explanation, it is considered non-AP station 110a supports the High-end STA Profile while AP station 100a supports the IoT STA Profile, Low latency STA Profile and High-end STA Profile.

At step 1000, non-AP station 110a and AP station 100a establish their association and until this association, they exchanged their supporting AIML capabilities as described above, by signalling their AIML Profile information in transmitted management frames. As a consequence, non-AP station 110a knows that AP station 100a supports the High-end STA Profile, meaning, e.g., it knows that AP station 100a supports model groups C and D for channel access use case as shown in FIG. 9.

Based on this information, non-AP station 110a may determine or select one of these model groups, i.e., it determines a model group associated with the AIML profile information included in the management frame sent by AP station 100a. Then, it may obtain or select an AIML model of the determined model group, to train it and/or use it.

For example, non-AP station 110a may decide to train its own (i.e., local) AIML model based on model group C. Training data may be obtained locally. Alternatively or in combination (to have more training data), non-AP station 110a may send an AIML Data Request frame 1001 to AP station 100a requesting training data for model group C for the channel access use case. In other words, non-AP station 110a requests AIML data to AP station 100a to train the AIML model.

An Action frame, namely an AIML Action frame (with “Category” field 501a/b mentioned above), can be used to that end. FIG. 11 illustrates an exemplary table of values for the Action field 502a/b. In addition to values ‘0’ and ‘1’ already described above (for AIML Request and AIML Response to obtain AIML capabilities), other values are defined to provide additional AIML action frames. Values 0-7 are used in the proposed table. Of course, any other values and assignments to the AIML Actions can be contemplated.

AIML Data Request frame 1001 may be identified using Action field set to 2.

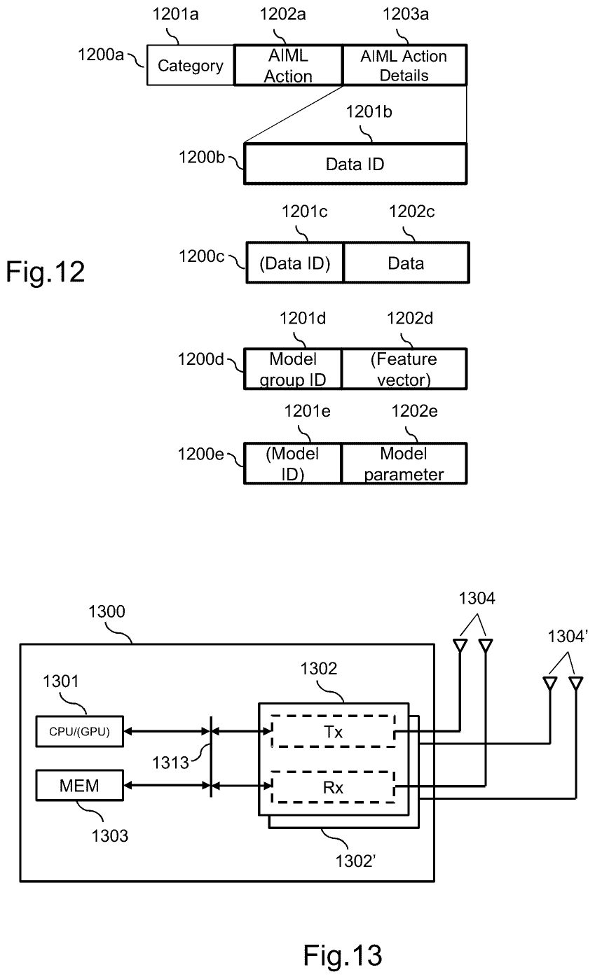

FIG. 12 illustrates exemplary formats for these AIML Action frames according to some embodiments of the invention. 1200a shows the basic format of an AIML Action frame.

Category field 1201a and AIML Action field 1202a are as defined above (FIGS. 5 and 11). Definition of AIML Action Details field 1203a differs depending on the value of the AIML Action field. FIG. 5 shows that AIML Profile version field 503a/b and AIML Profile Bitmap field 504a/b (or AIML Sub-profile fields) form the AIML Action Details field for the AIML Request/Response frame.

Format 1200b corresponds to an exemplary format for AIML Data Request frame 1001. Field 1201b indicates the ID to identify which data the station is requesting. This Data ID is pre-defined by any means (e.g., as an international standard, as a consensus among a group of stations) and all the stations supporting the data communication for AIML are able to identify the data by the Data ID.

Back to FIG. 10, AP station 100a can reply to AIML Data Request frame 1001 by sending AIML Data Response frame 1002 including the data requested by non-AP station 110a. For example, the “Buffer status of other stations” (or peers) may be the requested data because non-AP station 110a cannot know them while only AP station 100a knows them. Non-AP station can therefore receive such buffer status data for the training of the selected AIML model. The buffer status data may be integrated together with other information the non-AP station can collect/gather locally (e.g., Tx Power, CCA results, PER, Buffer status). Non-AP station 110a can then train the AIML model and subsequently use it.

AIML Data Request frame 1002 may be identified using Action field set to 3. Format 1200c corresponds to an exemplary format for AIML Data Response frame 1002. Field 1201c is the Data ID to identify the responding data. However, it may be optional for example if a Dialog Token is alternatively used in the Action frame to make a correspondence between the request and the response. Field 1202c includes the responded data, i.e., the buffer status data in the present example.

Alternatively to selecting an own (i.e., local) AIML model, non-AP station 110a may requests an AIML model for the determined model group (group C in the example), to AP station 100a. The AIML model may be trained. This allows non-AP station 110a to receive a pre-trained AIML model from AP station 100a using a transfer learning mechanism. The received AIML model may be further trained locally (by the non-AP station) using locally available training data.

In this case, non-AP station 110a sends AIML Model Request frame 1003 to AP station 100a indicating that it is an AIML model request for model group C for the channel access use case.

AIML Model Request frame 1003 may be identified using Action field set to 4. Format 1200d corresponds to an exemplary format for AIML Model Request frame 1003. Field 1201d includes a Model Group ID which identifies which group of AIML models the station is requesting (Group C in the above example). The Model group ID is pre-defined by any means (e.g., as an international standard, as a consensus among a group of stations) to identify separately groups A to D in the above example, and all the stations supporting the model communication for AIML are able to identify the model group by the Model group ID. Field 1202d is an optional Feature vector subfield that may contain a feature which represents requesting station's feature or features (e.g., environmental state information and/or internal state information). Such features may help the responding station (here AP station 100a) to evaluate which AIML model from amongst the signalled model group best fits the requesting station's conditions.

AP station 100a can reply to AIML Model Request frame 1003 either by searching in a local model database or forwarding the request to another AP station (e.g., AP station 100b) or by soliciting Cloud 120 if the latter stores an AIML model compatible with the requested model group (1011). If Cloud 120 is solicited, it sends back at step 1012 the compatible AIML model to AP 100a (optionally meeting as much as possible the features of the Feature vector), which forwards it back to non-AP station 110a using AIML Model Response frame 1004. If another AP station is solicited, the latter can search the AIML model in its local model database and sends it back to AP station 100a for further forward to non-AP station 110a or sends it directly to non-AP station 110a using an AIML Model Response frame. Otherwise, AP station 100a searches the AIML model in its local model database and sends it back to non-AP station 110a using AIML Model Response frame 1004.

AIML Model Response includes the necessary information defining the AIML model, e.g., neural network model parameters (numbers of hidden layers, numbers of nodes in each hidden layers, weights of each connection, any additional information for the neural network architecture such as connection between each node, activation function etc.).

AIML Model Response frame 1004 may be identified using Action field set to 5. Format 1200e corresponds to an exemplary format for AIML Model Response frame 1004. Field 1201e is an optional Model ID which identifies the responded AIML model. This Model ID is pre-defined by any means (e.g., as an international standard, as a consensus among a group of stations) and all the stations supporting the model communication for AIML are able to identify the AIML model by the Model ID. Field 1202e includes the parameters defining the AIML model. E.g., if the AIML model is based on neural network, the parameters may include data such as neural network architectures, weights of each connection and so on. Field 1202e is therefore adapted to the type of the AIML model to define.

Once the AIML model is received by non-AP station 110a, the latter deploys it, uses it and therefore optimizes the channel access operation based on the decision made by the used AIML model.

In embodiments, AP station 100a may respond to AIML Model Request frame 1003 with AIML Model Response 1004 indicating a failure of the request, for example when it fails to obtain a suited AIML model or when it wants to reject the request for any reason.

In some embodiments, non-AP station 110a may wish to update the obtained pre-trained AIML model by acquiring additional training data from AP station 100a. This is to obtain a further optimization since the training is done in the local environment of non-AP station 110a. In this case, AIML Data Request/Response 1001/1002 (already described) may be exchanged with AP station 100a after the pre-trained AIML model is received.

Of course, the AIML model may also be updated with new local training data.

In other embodiments, non-AP station 110a may wish to share the updated AIML model (after new training) to AP 100a and/or Cloud 120. In other words, the non-AP station tries to share an updated AIML model resulting from a training of the obtained AIML model, with the AP station. This may be done by sending the updated AIML model to AP 100a using AIML Model Update Request 1005. Where appropriate, AP 100a forwards the updated AIML model to Cloud 120 (1013).

AIML Model Update Request 1005 may be identified using Action field set to 6. Format 1200e (already defined above) may be used for AIML Model Update Request 1005.

AIML Model Update Response 1014 (from Cloud 120) and 1006 (from AP station 100a) may merely include an acknowledgement information that confirms the receipt of the updated AIML model.

In some embodiments related to a federated learning, the updated AIML model may be considered as a local AIML model forming part of a global AIML managed by AP station 100a (or Cloud 120). AP station 100a (or Cloud 120) may use AIML Model Update Response 1006 (and 1014) to feed back the global AIML model trained in AP station 100a (or Cloud 120) integrating the local AIML model received AIML Model Update Request 1005 and any other local AIML models collected from other stations connected to the same AP station. This allows the same optimized AIML model to be deployed over multiple non-AP stations. In this scenario, the updated AIML model forms part of a global AIML model managed by the AP station, and the non-AP station receives, in response to the sharing, an updated global AIML model.

The exemplary formats of FIG. 12 are only illustrative. The order of fields can be changed and any other fields not illustrated in the Figure such as a Dialog Token field or a Status Code field may be additionally included. Preferably, the resulting format follows at least the Action frame format rule specified in the IEEE 802.11 specification. The length of the AIML Action Details 1203a may be limited by the maximum allowed MMPDU (medium access control (MAC) management protocol data unit) size.

FIG. 13 schematically illustrates an example of a communication device, that may correspond any of the stations described by reference to FIG. 1, of a wireless network, configured to implement at least some embodiments of the present invention. The communication device, referenced 1300, may preferably be a device such as a micro-computer, a workstation, or a light portable device. Communication device 1300 may comprise a communication bus 1313 to which may be connected:
a central processing unit 1301, such as a processor, denoted CPU; and optionally a graphics processing unit, denoted GPU which allows powerful computation especially required for AIML operation
a memory 1303, denoted MEM, for storing an executable code of methods or steps of the methods according to embodiments of the invention as well as the registers adapted to record variables and parameters necessary for implementing the methods; and
at least two communication interfaces 1302 and 1302′ connected to the wireless communication network, for example a communication network according to one of the IEEE 802.11 family of standards, via transmitting and receiving antennas 1304 and 1304′, respectively.

Preferably, communication bus 1313 may provide communication and interoperability between the various elements included in the communication device 1300 or connected to it. The representation of the bus is not limiting and in particular the central processing unit is operable to communicate instructions to any element of the communication device 1300 directly or by means of another element of the communication device 1300.

The executable code may be stored in a memory that may either be read only, a hard disk, or on a removable digital medium such as for example a disk. According to an optional variant, the executable code of the programs can be received by means of the communication network, via the interface 1302 or 1302′, in order to be stored in the memory 1303 of communication device 1300 before being executed.

In some embodiments, communication device 1300 may be a programmable apparatus which uses software to implement embodiments of the invention. However, alternatively, some embodiments of the present invention may be implemented, totally or in partially, in hardware (for example, in the form of an Application Specific Integrated Circuit or ASIC).

Embodiment(s) of the present invention can also be realized by a computer of a system or apparatus that reads out and executes computer executable instructions (e.g., one or more programs) recorded on a storage medium (which may also be referred to more fully as a “non-transitory computer-readable storage medium”) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), etc.), a flash memory device, a memory card, and the like.

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed in be a reference to the plural and vice versa.

A person skilled in the art will readily appreciate that various parameters disclosed in the description may be modified and that various embodiments disclosed may be combined without departing from the scope of the invention.

1. A communication method in a wireless network, comprising at a first station:
transmitting, to a second station, a management frame including artificial intelligence and machine learning, AIML, profile information defining a profile of AIML capabilities at the first station, wherein the AIML profile information is based on pre-defined AIML profiles or sub-profiles.

2. A communication method in a wireless network, comprising at a second station:
receiving, from a first station, a management frame including artificial intelligence and machine learning, AIML, profile information defining a profile of AIML capabilities at the first station, wherein the AIML profile information is based on pre-defined AIML profiles or sub-profiles.

3. The method of claim 1, wherein the AIML profile information includes a bitmap, bits of which respectively mapping to pre-defined AIML profiles.

4. The method of claim 1, wherein the AIML profile information includes multiple AIML sub-profile fields corresponding to multiple parameters or sets of parameters composing an AIML profile, wherein each AIML sub-profile field of the multiple AIML sub-profile fields includes an index referencing a pre-defined AIML sub-profile for the corresponding parameter or set of parameters.

5. The method of claim 1, wherein the AIML profile information further includes AIML profile version information defining a set of pre-defined AIML profiles or sub-profiles available.

6. The method of claim 1, wherein the first station caches the AIML profile information in local memory and reuses the cached AIML profile information in a future management frame.

7. The method of claim 1, wherein the second station retrieves the AIML profile information from the received management frame and locally stores the retrieved AIML profile information as part of first station's information.

8. The method of claim 1, wherein the AIML profile information is included in a Reduced Neighbor Report, RNR, element or Neighbor Report, NR, element or Multi-Link element or Vendor Specific element as defined in the IEEE 802.11 family.

9. The method of claim 1, wherein the management frame is an Action frame including a Category field, an AIML Action field and the AIML profile information.

10. The method of claim 1, wherein the first station is a first access-point, AP, station, the second station is a non-AP station, and the non-AP station:
receives, from a second AP station, a second management frame including second AIML profile information defining a profile of AIML capabilities at the second AP station,
selects one of the first and second AP stations based on the received AIML profile information and second AIML profile information, and
requests association to the selected AP station.

11. The method of claim 1, wherein the first station is a non-access-point, AP, station, the second station is an AP station, and the AP station:
decides, based on the received AIML profile information, whether to accept or refuse an association of the non-AP station to a Basic Service Set, BSS, the AP station manages, and
transmits, to the non-AP station, an Association Response frame including an indication of the decided association acceptation or refusal.

12. The method of claim 1, wherein the profile of AIML capabilities is associated with one or more predefined model groups, each defining AIML models.

13. The method of claim 12, wherein the AIML models of the same model group have the same ML algorithm, the same input parameters, the same output parameters and the same optimization policy to train the AIML models.

14. The method of claim 12, wherein the first station is a first access-point, AP, station, the second station is a non-AP station, and the non-AP station:
determines a model group associated with the AIML profile information included in the management frame,
obtains an AIML model of the determined model group, and
requests AIML data to the AP station to train the obtained AIML model.

15. The method of claim 14, wherein the requested AIML data include buffer statuses of other stations in the network, to train an AIML model that drives channel access of the non-AP station.

16. The method of claim 14, wherein obtaining the AIML model includes requesting an AIML model for the determined model group, to the AP station.

17. The method of claim 16, wherein the requested AIML model is a pre-trained AIML model.

18. The method of claim 14, wherein the non-AP station shares an updated AIML model resulting from a training of the obtained AIML model, with the AP station.

19. The method of claim 18, wherein the updated AIML model forms part of a global AIML model managed by the AP station, and the non-AP station receives, in response to the sharing, an updated global AIML model.

20. The method of claim 1, wherein the profile of AIML capabilities defines one or more use cases that correspond to one or more communication mechanisms in which an AIML model complying with the AIML capabilities is to be used.

21. A first communication device in a wireless network, comprising a transmitter configured to transmit, to a second communication device of the wireless network, a management frame including artificial intelligence and machine learning, AIML, profile information defining a profile of AIML capabilities at the first communication device, wherein the AIML profile information is based on pre-defined AIML profiles or sub-profiles.

22. A second communication device in a wireless network, comprising a receiver configured to receive, from a first communication device of the wireless network, a management frame including artificial intelligence and machine learning, AIML, profile information defining a profile of AIML capabilities at the first communication device, wherein the AIML profile information is based on pre-defined AIML profiles or sub-profiles.

23. A non-transitory computer-readable medium storing a program which, when executed by a microprocessor or computer system in a communication device, causes the communication device to carry out the steps of the method of claim 1.
